(19) United States
(12) Patent Application Publication
(10) Pub. No.: US 2022/0215560 A1
(43) Pub. Date: Jul. 7, 2022

(54) METHOD AND DEVICE FOR TRACKING MULTIPLE TARGET OBJECTS IN MOTION STATE

(71) Applicant: Beijing Moviebook Science and Technology Co., Ltd., Beijing (CN)

(72) Inventor: Changjiang JI, Beijing (CN)

(73) Assignee: Beijing Moviebook Science and Technology Co., Ltd., Beijing (CN)

(21) Appl. No.: 17/620,119

(22) PCT Filed: Sep. 27, 2019
(86) PCT No.: PCT/CN2019/108432

§ 371 Date: Dec. 17, 2021

(30) Foreign Application Priority Data
Jun. 17, 2019 (CN) 201910522911.3

(51) Int. Cl. G06T 7/246; G06T 7/70; G06T 7/90

(52) U.S. Cl. CPC G06T 7/248; G06T 7/70; G06T 2207/10024; G06T 2207/10016; G06T 7/90

(57) ABSTRACT

A method and a device for tracking multiple target objects in a motion state, wherein the method includes: determining a feature detection area of a target object from a video frame captured by a video capture device, extracting color features of the target object from the detection area to perform comparison so as to obtain a first comparison result; comparing the position information of marked parts of target objects in adjacent video frames in a target coordinate system to obtain a second comparison result; and determining, according to the first comparison result and the second comparison result, whether the target objects in the adjacent video frames are the same target object, so as to implement accurate positioning and tracking. By using the method, multiple target objects can be quickly identified and tracked at the same time, and the accuracy of identifying and tracking target objects in video data are improved.

### CROSS REFERENCE TO THE RELATED APPLICATIONS

This application is the national phase entry of International Application No. PCT/CN2019/108432, filed on Sep. 27, 2019, which is based upon and claims priority to Chinese Patent Application No. 201910522911.3, filed on Jun. 17, 2019, the entire contents of which are incorporated herein by reference.

### TECHNICAL FIELD

The embodiments of the present disclosure relate to the field of artificial intelligence technology, and in particular to a method and device for tracking multiple target objects in a motion state.

### BACKGROUND

With rapid development of computer vision technology, functions of an existing video capture device are becoming more and more powerful, and a user can track and shoot a specific target object in video data through the video capture device. Computer vision technology is a technology that studies how to make machines “see”. Cameras and computer devices may be used to replace human eyes to perform machine vision processing technologies such as real-time recognition, positioning, tracking and measurement on the target object. An image is analyzed and processed by the computer device, so that the data obtained by the camera is more suitable for human observation or image information sent to an instrument for detection. For example, in a basketball game, it is usually necessary to use the camera to track and shoot multiple players on the court at the same time, so that the user can switch to the tracking and shooting angle corresponding to a player or obtain motion trajectory data of the player on the court at any time as required. Therefore, how to achieve rapid and accuracy positioning and tracking of the target object when the video capture device and the target object are both a motion state, has become a technical problem that needs to be solved urgently.

In order to solve the above technical problems, the technical means usually used in the conventional art is to determine a position similarity between the target objects in video frames based on 2D image recognition technology, and determine whether the target objects in adjacent video frames are the same target object, so as to realize the positioning and tracking of the target object and obtain a motion trajectory of the target object. However, in actual application scenarios, in addition to the target object being in a motion state, there are often changes in the pose of the video capture device itself, resulting in poor actual tracking and shooting effects of the target object in the conventional art. Identification errors are prone to occur, and the needs of current users cannot be met.

### SUMMARY

In view of this, a method for tracking multiple target objects in a motion state is provided according to the embodiments of the present disclosure, so as to solve the problem of low efficiency and poor accuracy in the recognition and tracking of multiple target objects in a video in the conventional art.

In order to achieve the foregoing objectives, following technical solutions are provided according to the embodiments of the present disclosure.

A method for tracking multiple target objects in a motion state is provided according to the embodiments of the present disclosure. The method includes: obtaining video frames included in video data captured by a video capture device; sending the video frames to a preset feature recognition model; determining, for each of the video frames, feature detection areas corresponding to the target objects respectively; extracting, for each of the target objects, a color feature of the target object from the feature detection area corresponding to the target object; and comparing the color features of the target objects in adjacent video frames to obtain a first comparison result; determining, for each of the adjacent video frames, position information of an identification part of the target object in a target coordinate system, and comparing the position information of the identification parts in the target coordinate system for the adjacent video frames to obtain a second comparison result; and determining whether the target objects in the adjacent video frames are the same target object based on the first comparison result and the second comparison result; regarding the target objects in the adjacent video frames as the same target object for tracking, in a case of determining that the target objects in the adjacent video frames are the same target object.

Furthermore, the determining, for each of the adjacent video frames, position information of an identification part of the target object in a target coordinate system includes: obtaining pose change information of the video capture device corresponding to each of the adjacent video frames by predicting a pose change state of the video capture device corresponding to each of the adjacent video frames; determining position information of the video capture device corresponding to a later video frame of the adjacent video frames based on the pose change information and position information of the video capture device corresponding to a former video frame of the adjacent video frames; obtaining, with a triangulation method, position information of the identification part of the target object in a spatial rectangular coordinate system constructed by taking the video capture device as a spatial coordinate origin, based on the position information of the video capture device corresponding to each of the adjacent video frames and the identification part of the target object; and performing coordinate transformation to obtain the position information of the identification part of the target object in the target coordinate system.

Furthermore, the method for tracking multiple target objects in a motion state further includes: determining an actual motion area of the target object in the video frame; and taking the actual motion area of the target object in the video frame as a to-be-detected area, and filtering out the feature detection areas outside the to-be-detected area to obtain the feature detection areas within the to-be-detected area.

Furthermore, the identification part is a neck part of the target object; and the position information of the identification part of the target object in the target coordinate system is position information of the neck part of the target object in a spatial rectangular coordinate system constructed by taking a center of the to-be-detected area as a spatial coordinate origin.

Furthermore, the method further includes: obtaining the video data captured by a video capture device, segmenting the video data to obtain video fragments included in the video data; detecting a feature similarity among the video fragments, and taking the video fragments, the feature similarity among which reaches or exceeds a preset similarity threshold and a time interval among which does not exceed a preset time threshold, as one video shot; and obtaining the video frames included in the video shot.

Correspondingly, a device for tracking multiple target objects in a motion state is provided according to the embodiments of the present disclosure. The device includes: a video frame obtaining unit configured to obtain video frames included in video data captured by a video capture device; a first comparison unit configured to: send the video frames to a preset feature recognition model; determine, for each of the video frames, feature detection areas corresponding to the target objects respectively; extract, for each of the target objects, a color feature of the target object from the feature detection area corresponding to the target object; and compare the color features of the target objects in adjacent video frames to obtain a first comparison result; a second comparison unit configured to: determine, for each of the adjacent video frames, position information of an identification part of the target object in a target coordinate system, and compare the position information of the identification parts in the target coordinate system for the adjacent video frames to obtain a second comparison result; and a determining unit configured to: determine whether the target objects in the adjacent video frames are the same target object based on the first comparison result and the second comparison result; regard the target objects in the adjacent video frames as the same target object for tracking, in a case of determining that the target objects in the adjacent video frames are the same target object.

Furthermore, the determining, for each of the adjacent video frames, position information of an identification part of the target object in a target coordinate system includes: obtaining pose change information of the video capture device corresponding to each of the adjacent video frames by predicting a pose change state of the video capture device corresponding to each of the adjacent video frames; determining position information of the video capture device corresponding to a later video frame of the adjacent video frames based on the pose change information and position information of the video capture device corresponding to a former video frame of the adjacent video frames; obtaining, with a triangulation method, position information of the identification part of the target object in a spatial rectangular coordinate system constructed by taking the video capture device as a spatial coordinate origin, based on the position information of the video capture device corresponding to each of the adjacent video frames and the identification part of the target object; and performing coordinate transformation to obtain the position information of the identification part of the target object in the target coordinate system.

Furthermore, the device for tracking multiple target objects in a motion state further includes: a motion area determining unit configured to determine an actual motion area of the target object in the video frame; a filtering unit configured to take the actual motion area of the target object in the video frame as a to-be-detected area, and filter out the feature detection areas outside the to-be-detected area to obtain the feature detection areas within the to-be-detected area.

Furthermore, the identification part is a neck part of the target object; and the position information of the identification part of the target object in the target coordinate system is position information of the neck part of the target object in a spatial rectangular coordinate system constructed by taking a center of the to-be-detected area as a spatial coordinate origin.

Furthermore, the obtaining video frames included in video data captured by a video capture device includes: obtaining the video data captured by a video capture device, segmenting the video data to obtain video fragments included in the video data; detecting a feature similarity among the video fragments, and taking the video fragments, the feature similarity among which reaches or exceeds a preset similarity threshold and a time interval among which does not exceed a preset time threshold, as one video shot; and obtaining the video frames included in the video shot.

Correspondingly, an electronic device is provided according to the disclosure. The electronic device includes: a processor; and a memory configured to store a program for a method for tracking multiple target objects in a motion state. After the device is powered on and the processor runs the program for the method for tracking multiple target objects in a motion state, the device performs following steps: obtaining video frames included in video data captured by a video capture device; sending the video frames to a preset feature recognition model; determining, for each of the video frames, feature detection areas corresponding to the target objects respectively; extracting, for each of the target objects, a color feature of the target object from the feature detection area corresponding to the target object; and comparing the color features of the target objects in adjacent video frames to obtain a first comparison result; determining, for each of the adjacent video frames, position information of an identification part of the target object in a target coordinate system, and comparing the position information of the identification parts in the target coordinate system for the adjacent video frames to obtain a second comparison result; and determining whether the target objects in the adjacent video frames are the same target object based on the first comparison result and the second comparison result; regarding the target objects in the adjacent video frames as the same target object for tracking, in a case of determining that the target objects in the adjacent video frames are the same target object.

Correspondingly, a storage device is provided according to the disclosure. The storage device stores a program for a method for tracking multiple target objects in a motion state. A processor runs the program to performs following steps: obtaining video frames included in video data captured by a video capture device; sending the video frames to a preset feature recognition model; determining, for each of the video frames, feature detection areas corresponding to the target objects respectively; extracting, for each of the target objects, a color feature of the target object from the feature detection area corresponding to the target object; and comparing the color features of the target objects in adjacent video frames to obtain a first comparison result; determining, for each of the adjacent video frames, position information of an identification part of the target object in a target coordinate system, and comparing the position information of the identification parts in the target coordinate system for the adjacent video frames to obtain a second comparison result; and determining whether the target objects in the adjacent video frames are the same target object based on the first comparison result and the second comparison result; regarding the target objects in the adjacent video frames as the same target object for tracking, in a case of determining that the target objects in the adjacent video frames are the same target object.

According to the method for tracking multiple target objects in a motion state in this disclosure, multiple target objects in a motion state may be recognizes and tracked simultaneously in a high speed. In this way, an accuracy of the recognition and tracking of multiple target objects of video data in a motion state is improved, and the user experience is improved.

### BRIEF DESCRIPTION OF THE DRAWINGS

In order to illustrate solutions of the embodiments of the present disclosure or in the conventional technology more clearly, the drawings used in the description of the embodiments or the conventional technology are briefly described below. It is apparent that the drawings in the following description are only exemplary. For those of ordinary skill in the art, other implementation drawings can be derived from the provided drawings without any creative work.

The structure, proportion, and size shown in the drawings of the specification are only used to match the contents disclosed in the specification for those skilled in the art to understand and read and are not intend to limit the conditions under which the present disclosure can be implemented, having no technically significance. Any modification of structure, change of proportional relationship, or adjustment of size should still fall within the scope of the technical content disclosed in the present disclosure without affecting the efficacy and purpose of the present disclosure.

FIG. 1 is a flowchart of a method for tracking multiple target objects in a motion state according to an embodiment of the disclosure;

FIG. 2 is a schematic diagram of a device for tracking multiple target objects in a motion state according to an embodiment of the disclosure;

FIG. 3 is a schematic diagram of positioning a target object by using a triangulation method according to an embodiment of the disclosure; and

FIG. 4 is a schematic diagram of an electronic device according to an embodiment of the disclosure.

### DETAILED DESCRIPTION OF THE EMBODIMENTS

The embodiments of the present disclosure are illustrated below by the specific examples. Those familiar with this technology can easily understand the other advantages and effects of the present disclosure from the contents disclosed in this specification. It is apparent that the described embodiments are only some rather than all of the embodiments of the present disclosure. All the other embodiments obtained by those skilled in the art based on the embodiments in the present disclosure without any creative work fall into the scope of the present disclosure.

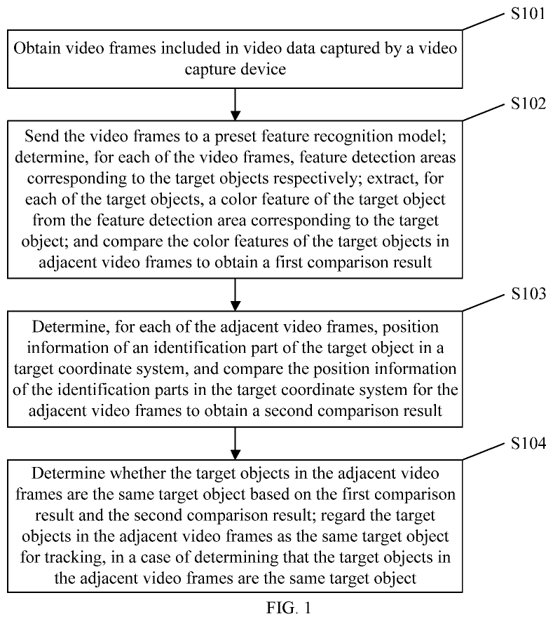

The embodiments of the disclosure are described in detail by describing a method for tracking multiple target objects in a motion state according to the disclosure. As shown in FIG. 1, which is a flowchart of a method for tracking multiple target objects in a motion state according to an embodiment of the disclosure, the method includes step S101 to S104.

Step S101: obtain video frames included in video data captured by a video capture device.

In the embodiments of the present disclosure, the video capture device includes video data capture equipment such as a camera, a video recorder, and an image sensor. The video data is video data included in an independent shot. One independent lens is video data obtained by the video capture device in a continuous shooting process. The video data includes video frames, and a group of continuous video frames form one shot.

A complete video data may include multiple shots, and the obtaining of the video frames included in the video data captured by the video capture device may be specifically implemented by the following steps: obtaining the video data captured by the video capture device; before obtaining the video frames included in one shot, performing shot segmentation on the complete video data based on a global feature and a local feature of the video frames to obtain a series of independent video fragments; detecting a similarity among the video fragments, and taking the video fragments, the similarity among which reaches or exceeds a preset similarity threshold and a time interval among which does not exceed a preset time threshold, as one video shot; and obtaining the video frames included in the video shot.

In a specific implementation process, the color features of the video frames in different shots usually have obvious differences. When the color features of two adjacent video frames change, it can be considered that the shot switch has occurred here. An RGB or HSV color histogram of each video frame in the video data may be extracted with a color feature extraction algorithm, and probability distributions of a former half and a later half of the video frames are calculated with a window function. If the two probability distributions are different, it is considered that the current window center is the shot boundary.

The performing shot segmentation on the complete video data based on a global feature and a local feature of the video frames may be specifically implemented through the following process.

Global feature analysis: calculate a first similarity between adjacent video frames of video data based on the color features of the adjacent video frames; compare the first similarity with a first similarity threshold; take the video frame as a candidate video frame of an independent shot if the first similarity is less than the first similarity threshold.

Local feature analysis: calculate, for each of the candidate video frame and previous video frame previous to the candidate video frame, a distance value between a descriptor of a key point to each visual word; correspond the descriptor with the visual word having the smallest distance value; construct, for each of the candidate video frame and the previous video frame, a visual word histograms based on the descriptor and the visual words corresponding to the descriptor; and calculate a second similarity between the visual word histograms of the video frames.

Shot segmentation steps: compare the second similarity with a second similarity threshold; merge the candidate video frame and the previous video frame into the same shot if the second similarity is greater than or equal to the second similarity threshold; determine the candidate video frame as a starting video frame of a new shot if the second similarity is less than the second similarity threshold.

Step S102: send the video frames to a preset feature recognition model; determine, for each of the video frames, feature detection areas corresponding to the target objects respectively; extract, for each of the target objects, a color feature of the target object from the feature detection area corresponding to the target object; and compare the color features of the target objects in adjacent video frames to obtain a first comparison result.

The operation, of obtaining the video frames included in the video data captured by the video capture device in the above step S101, has done data preparation for this step to compare the color features of the target object in the adjacent video frames. In step S102, the color feature of the target object may be extracted from the video frame, and the color features of the target objects in the adjacent video frames may be compared to obtain the first comparison result.

In the embodiments of the present disclosure, the feature recognition model may refer to the Faster RCNN deep neural network model obtained through iterative training in advance. The feature detection area may refer to a detection block corresponding to each target object in the video frame obtained during the process of using the Faster RCNN deep neural network model to detect the target object on the video frame.

Specifically, considering that the RGB (red, green, blue) color or HSV (Hue Saturation Value) color of each pixel position in the to-be-detected area corresponding to each target object in the adjacent video frames are usually the same or similar, therefore, the color feature of the target object may be extracted from the to-be-detected area, and the color features of the target objects in the adjacent video frames may be compared to obtain the first comparison result, i.e., the similarity between the color features of the target objects in the adjacent video frames.

Considering that in the actual implementation process, when determining the feature detection areas corresponding to the target objects in the video frame, there may be a detection area generated for a non-target object (that is, the detection block corresponding to the non-target object) in the final detection result, therefore, the above detection result needs to be filtered in advance, and only the feature detection area corresponding to the target object (that is, the detection block corresponding to the target object) is retained. The specific implementation is as follows: determine an actual motion area of the target object in the video frame; and take the actual motion area of the target object in the video frame as a to-be-detected area, and filter out the feature detection areas outside the to-be-detected area to obtain the feature detection areas within the to-be-detected area. The actual motion area is a motion area of the target object.

Take a basketball game as an example to illustrate the above implementation. In the basketball game, it is first necessary to use the feature recognition model to detect players contained in each video frame, to obtain a detection block corresponding to each player (i.e., the target object) in the video frame, and record an ID that uniquely identifies the player. In this case, a corresponding detection block may also be generated for a spectator (that is, a non-target object) outside the court. However, the spectator is not the target object that needs to be positioned and tracked. Therefore, the detection block corresponding to the spectator needs to be filtered out and only the detection blocks within the court are retained. Specifically, the difference between the color feature of the court floor and the color feature of the auditorium may be used to differentiate and filter through the a threshold filtering method to obtain an image containing only the court, and a series of processing operations such as corrosion and expansion are further performed on the image of the court, to obtain an outer contour of the court (an area enclosed by the outer contour is the actual motion area of the target object), the detection blocks outside the outer contour of the court are filtered out, and only the detection blocks within the area enclosed by the outer contour (that is, the court) are retained.

Step S103: determine, for each of the adjacent video frames, position information of an identification part of the target object in a target coordinate system, and compare the position information of the identification parts in the target coordinate system for the adjacent video frames to obtain a second comparison result.

After the first comparison result is obtained in the above step S102, in step S103, the position information of the identification part of the target object in the target coordinate system may be determined for each of the adjacent video frames, and the position information of the identification parts in the target coordinate system for the adjacent video frames are compared to obtain the second comparison result.

In the embodiments of the present disclosure, the target coordinate system may refer to a world coordinate system. The world coordinate system may refer to an absolute coordinate system of the video frames. A specific position of each target object in the world coordinate system may be determined based on coordinates of the points corresponding to the identification parts of all target objects in the video frame. The world coordinate system may refer to a spatial rectangular coordinate system constructed by taking a center of the detection area as a spatial coordinate origin.

As shown in FIG. 3, FIG. 3 is a schematic diagram of positioning a target object by using a triangulation method according to an embodiment of the disclosure. The point P may refer to the position of the point corresponding to the neck part of the target object. The point Q1 may refer to the position of the point corresponding to the video capture device in a former video frame, or it may refer to the position of the point corresponding to the video capture device in a former shot. The point Q2 may refer to the position of the point corresponding to the video capture device in a later video frame relative to the former video frame, or it may refer to the position of the point corresponding to the video capture device in a later shot relative to the former shot.

The determination of the position information of the identification part of the target object in the target coordinate system for each of the adjacent video frames may be specifically implemented in the following manner.

First, for each shot in the above-mentioned complete video data, a pose change of the video capture device may be predicted with a visual mileage calculation method (feature point method). A pose change state of the video capture device corresponding to each of the adjacent video frames may be obtained through the prediction, and then pose change information of the video capture device corresponding to each of the adjacent video frames may be obtained. The position information of the video capture device corresponding to each of the adjacent video frames may be determined based on the pose change information.

Here, position information of the video capture device corresponding to a former video frame of the adjacent video frames may be recorded as a first position, and position information of the video capture device corresponding to a later video frame of the adjacent video frames may be recorded as a second position.

Position information of the target object in a spatial rectangular coordinate system, constructed by taking the video capture device as a spatial coordinate origin, may be obtained with a triangulation method shown in FIG. 3, based on the first position and the second position of the video capture device corresponding to the adjacent video frames and the position of the point corresponding to the identification part. The position information of the target object in the target coordinate system (i.e., the world coordinate system) may be obtained through coordinate transformation. The pose change includes changes in the motion trajectory and the activity posture, and so on.

It should be noted that, in order to facilitate accurate positioning and tracking of the target object, the identification part may be a neck part of the target object. The position information of the identification part of the target object in the target coordinate system is position information of the neck part in a spatial rectangular coordinate system constructed by taking a center of the to-be-detected area as a spatial coordinate origin. Specifically, in the feature detection area, a bone detection algorithm may be used to obtain the point P corresponding to the neck part of each target object.

Step S104: determine whether the target objects in the adjacent video frames are the same target object based on the first comparison result and the second comparison result; regard the target objects in the adjacent video frames as the same target object for tracking, in a case of determining that the target objects in the adjacent video frames are the same target object.

After obtaining the first comparison result and the second comparison result in step S102 and step S103 respectively, in step S104, whether the target objects in the adjacent video frames are the same target object may be determined based on the first comparison result and the second comparison result, so as to realize real-time positioning and tracking of the target object.

In the embodiment of the present disclosure, whether a similarity between the target objects in the adjacent video frames is greater than a preset similarity threshold is determined based on the first comparison result and the second comparison result. The target objects in the adjacent video frames are regarded as the same target object for positioning and tracking, in a case of determining that the similarity between the target objects in the adjacent video frames is greater than the preset similarity threshold.

Specifically, based on the similarity between the color features and position information of the target objects in two adjacent video frames, the calculation may be performed by using a similarity function with a pairwise comparison manner. The similarity function is defined as follows:

Sim(playerᵢ,playerⱼ)=−(Sim(bᵢ,bⱼ)+Sim(Pᵢ,Pⱼ));

Sim(playerᵢ, playerⱼ) presents the similarity between the target objects of two adjacent video frames; each target object in the two adjacent video frames is recorded as playerᵢ=(bᵢ, Pᵢ); Sim(bᵢ,bⱼ)=|f(bᵢ)−f(bⱼ)|, the function f is an appearance feature extraction function; a color feature similarity Sim(bᵢ, bⱼ) of the target objects in two adjacent video frames may be obtained by using the Histogram of Oriented Gradient (HOG) method; Sim(Pᵢ, Pⱼ) represents a square of the Euclidean distance between two points Pᵢ and Pⱼ.

A similarity threshold T is set in advance. In a case that the similarity Sim(playerᵢ, playerⱼ) between the target objects of the two adjacent video frames is equal to or greater than T, the two adjacent video frames may be regarded as the same target object, and the target objects in the any two adjacent video frames are regarded as the same target object, and the trajectories are merged to realize accurate recognition and tracking of the target object.

According to the method for tracking multiple target objects in a motion state in this disclosure, multiple target objects in a motion state may be recognizes and tracked simultaneously in a high speed. In this way, an accuracy of the tracking of multiple target objects of video data in a motion state is improved, and the user experience is improved.

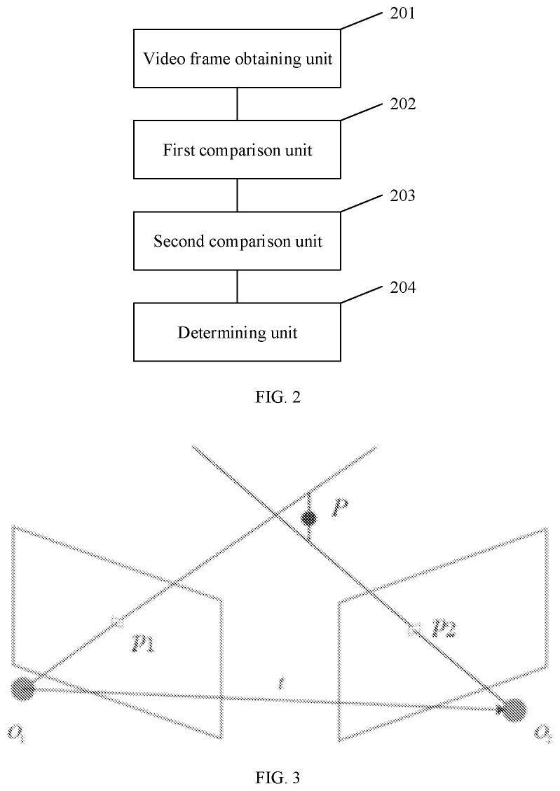

Corresponding to the above-mentioned method for tracking multiple target objects in a motion state, a device for tracking multiple target objects in a motion state is provided according to the present disclosure. Since the device embodiment is similar to the above method embodiment, the description of the device embodiment is relatively simple. The description of the above method embodiment may be referred for related details. The following description for the embodiment of the device for tracking multiple target objects in a motion state is illustrative. Reference is made to FIG. 2, which is a schematic diagram of a device for tracking multiple target objects in a motion state according to an embodiment of the disclosure.

The device for tracking multiple target objects in a motion state according to the present disclosure includes a video frame obtaining unit 201, a first comparison unit 202, a second comparison unit 203 and a determining unit 204.

The video frame obtaining unit 201 is configured to obtain video frames included in video data captured by a video capture device.

In the embodiments of the present disclosure, the video capture device includes video data capture equipment such as a camera, a video recorder, and an image sensor. The video data is video data included in an independent shot. One independent lens is video data obtained by the video capture device in a continuous shooting process. The video data includes video frames, and a group of continuous video frames form one shot.

A complete video data may include multiple shots, and the obtaining of the video frames included in the video data captured by the video capture device may be specifically implemented by the following steps: obtaining the video data captured by the video capture device; before obtaining the video frames included in one shot, performing shot segmentation on the complete video data based on a global feature and a local feature of the video frames to obtain a series of independent video fragments; detecting a similarity among the video fragments, and taking the video fragments, the similarity among which reaches or exceeds a preset similarity threshold and a time interval among which does not exceed a preset time threshold, as one video shot; and obtaining the video frames included in the video shot.

In a specific implementation process, the color features of the video frames in different shots usually have obvious differences. When the color features of two adjacent video frames change, it can be considered that the shot switch has occurred here. An RGB or HSV color histogram of each video frame in the video data may be extracted with a color feature extraction algorithm, and probability distributions of a former half and a later half of the video frames are calculated with a window function. If the two probability distributions are different, it is considered that the current window center is the shot boundary.

The first comparison unit 202 is configured to: send the video frames to a preset feature recognition model; determine, for each of the video frames, feature detection areas corresponding to the target objects respectively; extract, for each of the target objects, a color feature of the target object from the feature detection area corresponding to the target object; and compare the color features of the target objects in adjacent video frames to obtain a first comparison result.

In the embodiments of the present disclosure, the feature recognition model may refer to the Faster RCNN deep neural network model. The feature detection area may refer to a detection block corresponding to each target object in the video frame obtained during the process of using the Faster RCNN deep neural network model to detect the target object on the video frame.

Specifically, considering that the RGB (red, green, blue) color or HSV (Hue Saturation Value) color of each pixel position in the to-be-detected area corresponding to each target object in the adjacent video frames are usually the same or similar, therefore, the color feature of the target object may be extracted from the to-be-detected area, and the color features of the target objects in the adjacent video frames may be compared to obtain the first comparison result.

Considering that in the actual implementation process, when determining the feature detection areas corresponding to the target objects in the video frame, there may be a detection area generated for a non-target object in the final detection result, therefore, the above detection result needs to be filtered in advance, and only the feature detection area corresponding to the target object is retained. The specific implementation is as follows: determine an actual motion area of the target object in the video frame; and take the actual motion area of the target object in the video frame as a to-be-detected area, and filter out the feature detection areas outside the to-be-detected area to obtain the feature detection areas within the to-be-detected area.

The second comparison unit 203 is configured to: determine, for each of the adjacent video frames, position information of an identification part of the target object in a target coordinate system, and compare the position information of the identification parts in the target coordinate system for the adjacent video frames to obtain a second comparison result.

In the embodiments of the present disclosure, the target coordinate system may refer to a world coordinate system. The world coordinate system may refer to an absolute coordinate system of the video frames. A specific position of each target object in the world coordinate system may be determined based on coordinates of the points corresponding to the identification parts of all target objects in the video frame. The world coordinate system may refer to a spatial rectangular coordinate system constructed by taking a center of the detection area as a spatial coordinate origin.

As shown in FIG. 3, FIG. 3 is a schematic diagram of positioning a target object by using a triangulation method according to an embodiment of the disclosure. The point P may refer to the position of the point corresponding to the neck part of the target object. The point Q1 may refer to the position of the point corresponding to the video capture device in a former video frame, or it may refer to the position of the point corresponding to the video capture device in a former shot. The point Q2 may refer to the position of the point corresponding to the video capture device in a later video frame relative to the former video frame, or it may refer to the position of the point corresponding to the video capture device in a later shot relative to the former shot.

The determination of the position information of the identification part of the target object in the target coordinate system for each of the adjacent video frames may be specifically implemented in the following manner.

First, for each shot in the above-mentioned complete video data, a pose change of the video capture device may be predicted with a visual mileage calculation method (feature point method). A pose change state of the video capture device corresponding to each of the adjacent video frames may be obtained through the prediction, and then pose change information of the video capture device corresponding to each of the adjacent video frames may be obtained. The position information of the video capture device corresponding to each of the adjacent video frames may be determined based on the pose change information.

Here, position information of the video capture device corresponding to a former video frame of the adjacent video frames may be recorded as a first position, and position information of the video capture device corresponding to a later video frame of the adjacent video frames may be recorded as a second position.

Position information of the target object in a spatial rectangular coordinate system, constructed by taking the video capture device as a spatial coordinate origin, may be obtained with a triangulation method shown in FIG. 3, based on the first position and the second position of the video capture device corresponding to the adjacent video frames and the position of the point corresponding to the identification part. The position information of the target object in the target coordinate system (i.e., the world coordinate system) may be obtained through coordinate transformation. The pose change includes changes in the motion trajectory and the activity posture, and so on.

It should be noted that, in order to facilitate accurate positioning and tracking of the target object, the identification part may be a neck part of the target object. The position information of the identification part of the target object in the target coordinate system is position information of the neck part in a spatial rectangular coordinate system constructed by taking a center of the to-be-detected area as a spatial coordinate origin. Specifically, in the feature detection area, a bone detection algorithm may be used to obtain the point P corresponding to the neck part of each target object.

The determining unit 204 is configured to: determine whether the target objects in the adjacent video frames are the same target object based on the first comparison result and the second comparison result; regard the target objects in the adjacent video frames as the same target object for tracking, in a case of determining that the target objects in the adjacent video frames are the same target object.

In the embodiment of the present disclosure, whether a similarity between the target objects in the adjacent video frames is greater than a preset similarity threshold is determined based on the first comparison result and the second comparison result. The target objects in the adjacent video frames are regarded as the same target object for positioning and tracking, in a case of determining that the similarity between the target objects in the adjacent video frames is greater than the preset similarity threshold.

Specifically, based on the similarity between the color features and position information of the target objects in two adjacent video frames, the calculation may be performed by using a similarity function with a pairwise comparison manner. The similarity function is defined as follows:

Sim(playerᵢ,playerⱼ)=−(Sim(bᵢ,bⱼ)+Sim(Pᵢ,Pⱼ));

Sim(playerᵢ, playerⱼ) represents the similarity between the target objects of two adjacent video frames; each target object in the two adjacent video frames is recorded as playerᵢ=(bᵢ, Pᵢ); Sim(bᵢ,bⱼ)=|f(bᵢ)−f(bⱼ)|, the function f is an appearance feature extraction function; a color feature similarity Sim(bᵢ, bⱼ) of the target objects in two adjacent video frames may be obtained by using the Histogram of Oriented Gradient (HOG) method; P represents a square of the Euclidean distance between two points Pᵢ and Pⱼ.

A similarity threshold T is set in advance. In a case that the similarity Sim(playerᵢ, playerⱼ) between the target objects of the two adjacent video frames is equal to or greater than T, the two adjacent video frames may be regarded as the same target object, and the trajectories are merged.

According to the device for tracking multiple target objects in a motion state in this disclosure, multiple target objects in a motion state may be recognizes and tracked simultaneously in a high speed. In this way, an accuracy of the tracking of multiple target objects of video data in a motion state is improved, and the user experience is improved.

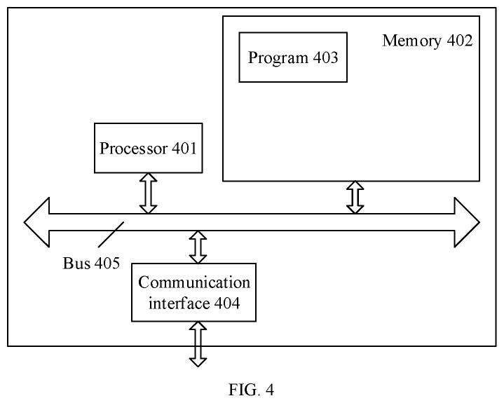

Corresponding to the above-mentioned method for tracking multiple target objects in a motion state, an electronic device and a storage device are provided according to the present disclosure. Since the electronic device embodiment is similar to the above method embodiment, the description of the electronic device embodiment is relatively simple. The description of the above method embodiment may be referred for related details. The following description for the embodiment of the electronic device and the embodiment of the storage device is illustrative. Reference is made to FIG. 4, which is a schematic diagram of an electronic device according to an embodiment of the disclosure.

An electronic device is provided according to the disclosure. The electronic device includes: a processor 401; and a memory 402 configured to store a program for a method for tracking multiple target objects in a motion state. After the device is powered on and the processor runs the program for the method for tracking multiple target objects in a motion state, the device performs following steps: obtaining video frames included in video data captured by a video capture device; sending the video frames to a preset feature recognition model; determining, for each of the video frames, feature detection areas corresponding to the target objects respectively; extracting, for each of the target objects, a color feature of the target object from the feature detection area corresponding to the target object; and comparing the color features of the target objects in adjacent video frames to obtain a first comparison result; determining, for each of the adjacent video frames, position information of an identification part of the target object in a target coordinate system, and comparing the position information of the identification parts in the target coordinate system for the adjacent video frames to obtain a second comparison result; and determining whether the target objects in the adjacent video frames are the same target object based on the first comparison result and the second comparison result; regarding the target objects in the adjacent video frames as the same target object for tracking, in a case of determining that the target objects in the adjacent video frames are the same target object.

A storage device is provided according to the disclosure. The storage device stores a program for a method for tracking multiple target objects in a motion state. A processor runs the program to performs following steps: obtaining video frames included in video data captured by a video capture device; sending the video frames to a preset feature recognition model; determining, for each of the video frames, feature detection areas corresponding to the target objects respectively; extracting, for each of the target objects, a color feature of the target object from the feature detection area corresponding to the target object; and comparing the color features of the target objects in adjacent video frames to obtain a first comparison result; determining, for each of the adjacent video frames, position information of an identification part of the target object in a target coordinate system, and comparing the position information of the identification parts in the target coordinate system for the adjacent video frames to obtain a second comparison result; and determining whether the target objects in the adjacent video frames are the same target object based on the first comparison result and the second comparison result; regarding the target objects in the adjacent video frames as the same target object for tracking, in a case of determining that the target objects in the adjacent video frames are the same target object.

In the embodiments of the present disclosure, the processor or processor module may be an integrated circuit chip with signal processing capability. The processor may be a general-purpose processor, a digital signal processor (DSP for short), an application specific integrated circuit (ASIC for short), and a field programmable gate array (FPGA for short) or other programmable logic devices, discrete gates or transistor logic devices, discrete hardware components.

The processor may implement or execute methods, steps and logical block diagrams disclosed in the embodiments of the present disclosure. The general-purpose processor may be a microprocessor or any conventional processor. Steps of the method disclosed in conjunction with the embodiments of the present disclosure may be performed by a hardware decoding processor or may be performed by a hardware module in combination with a software module in the decoding processor. The software module may be positioned in the conventional storage medium in the art, for example a random memory, a flash memory, a read only memory, a programmable read only memory, an electric erasable programmable memory, or a register. The processor reads the information in the storage medium and completes the steps of the above method in combination with its hardware.

The storage medium may be a memory, for example, may be a volatile memory or a non-volatile memory, or may include both volatile memory and non-volatile memory.

The non-volatile memory may be a read-only memory (ROM for short), a programmable ROM (PROM for short), and an erasable PROM (EPROM for short), electrically EPROM (EEPROM for short) or flash memory.

The volatile memory may be a random access memory (RAM for short), which is used as an external cache. By way of exemplary but not restrictive description, many forms of RAM are available, such as static RAM (SRAM for short), dynamic RAM (DRAM for short), and synchronous DRAM (SDRAM for short), double data rate SDRAM (DDRSDRAM for short), enhanced SDRAM (ESDRAM for short), synchlink DRAM (SLDRAM for short) and Direct Ram bus RAM (DRRAM for short).

The storage medium described in the embodiments of the present disclosure are intended to include, but are not limited to, these and any other suitable types of memories.

A person skilled in the art may realize that, in the foregoing one or more examples, the functions described in the present disclosure may be implemented by using combination of hardware and software. When the functions are implemented by software, these functions may be stored in a computer-readable medium or transmitted as one or more instructions or code in the computer-readable medium. The computer-readable medium includes a computer storage medium and a communications medium. The communications medium includes any medium that enables a computer program to be transmitted from one place to another. The storage medium may be any available medium accessible to a general or specific computer.

In the foregoing specific implementations, the objective, technical solutions, and beneficial effects of the present disclosure are further described in detail. It should be understood that the foregoing descriptions are merely specific implementations of the present disclosure, but are not intended to limit the protection scope of the present disclosure. Any modification, equivalent replacement, or improvement made based on the technical solutions of the present disclosure should fall within the protection scope of the present disclosure.

What is claimed is:

1. A method for tracking a plurality of target objects in a motion state, comprising:
obtaining video frames comprised in video data captured by a video capture device;
sending the video frames to a preset feature recognition model; determining, for each of the video frames, feature detection areas corresponding to the target objects respectively; extracting, for each of the target objects, a color feature of each of the target objects from each of the feature detection areas corresponding to each of the target objects; and comparing the color feature of each of the target objects in each of adjacent video frames to obtain a first comparison result;
determining, for each of the adjacent video frames, position information of an identification part of each of the target objects in each of the adjacent video frames in a target coordinate system, and comparing the position information of the identification part in the target coordinate system for each of the adjacent video frames to obtain a second comparison result; and
determining whether the target objects in each of the adjacent video frames are the same target object based on the first comparison result and the second comparison result; regarding the target objects in each of the adjacent video frames as the same target object for tracking, in a case of determining that the target objects in each of the adjacent video frames are the same target object.

2. The method for tracking the plurality of target objects in the motion state according to claim 1, wherein the step of determining, for each of the adjacent video frames, the position information of the identification part of each of the target objects in each of the adjacent video frames in the target coordinate system comprises:
obtaining pose change information of the video capture device corresponding to each of the adjacent video frames by predicting a pose change state of the video capture device corresponding to each of the adjacent video frames;
determining position information of the video capture device corresponding to a later video frame of each of the adjacent video frames based on the pose change information and position information of the video capture device corresponding to a former video frame of each of the adjacent video frames;
obtaining, with a triangulation method, the position information of the identification part of each of the target objects in a spatial rectangular coordinate system constructed by taking the video capture device as a spatial coordinate origin, based on the position information of the video capture device corresponding to each of the adjacent video frames and the identification part of each of the target objects in each of the adjacent video frames; and
performing a coordinate transformation to obtain the position information of the identification part of each of the target objects in each of the adjacent video frames in the target coordinate system.

3. The method for tracking the plurality of target objects in the motion state according to claim 1, further comprising:
determining an actual motion area of each of the target objects in the video frames; and
taking the actual motion area of each of the target objects in the video frames as a to-be-detected area, and filtering out the feature detection areas outside the to-be-detected area to obtain the feature detection areas within the to-be-detected area.

4. The method for tracking the plurality of target objects in the motion state according to claim 3, wherein
the identification part is a neck part of each of the target objects; and
the position information of the identification part of each of the target objects in the target coordinate system is position information of the neck part of each of the target objects in a spatial rectangular coordinate system constructed by taking a center of the to-be-detected area as a spatial coordinate origin.

5. The method for tracking the plurality of target objects in the motion state according to claim 1, wherein the step of obtaining the video frames comprised in the video data captured by the video capture device comprises:
obtaining the video data captured by the video capture device, segmenting the video data to obtain video fragments comprised in the video data;
detecting a feature similarity among the video fragments, and taking the video fragments, the feature similarity reaching or exceeding a preset similarity threshold and a time interval not exceeding a preset time threshold, as one video shot; and
obtaining the video frames comprised in the one video shot.

6. A device for tracking a plurality of target objects in a motion state, comprising:
a video frame obtaining unit configured to obtain video frames comprised in video data captured by a video capture device;
a first comparison unit configured to: send the video frames to a preset feature recognition model; determining, for each of the video frames, feature detection areas corresponding to the target objects respectively; extracting, for each of the target objects, a color feature of each of the target objects from each of the feature detection areas corresponding to each of the target objects; and comparing the color feature of each of the target objects in each of adjacent video frames to obtain a first comparison result;
a second comparison unit configured to: determine, for each of the adjacent video frames, position information of an identification part of each of the target objects in each of the adjacent video frames in a target coordinate system, and comparing the position information of the identification part in the target coordinate system for each of the adjacent video frames to obtain a second comparison result; and
a determining unit configured to: determine whether the target objects in each of the adjacent video frames are the same target object based on the first comparison result and the second comparison result; regarding the target objects in each of the adjacent video frames as the same target object for tracking, in a case of determining that the target objects in each of the adjacent video frames are the same target object.

7. The device for tracking the plurality of target objects in the motion state according to claim 6, wherein the step of determining, for each of the adjacent video frames, the position information of the identification part of each of the target objects in each of the adjacent video frames in the target coordinate system comprises:
obtaining pose change information of the video capture device corresponding to each of the adjacent video frames by predicting a pose change state of the video capture device corresponding to each of the adjacent video frames;
determining position information of the video capture device corresponding to a later video frame of each of the adjacent video frames based on the pose change information and position information of the video capture device corresponding to a former video frame of each of the adjacent video frames;
obtaining, with a triangulation method, the position information of the identification part of each of the target objects in a spatial rectangular coordinate system constructed by taking the video capture device as a spatial coordinate origin, based on the position information of the video capture device corresponding to each of the adjacent video frames and the identification part of each of the target objects in each of the adjacent video frames; and
performing a coordinate transformation to obtain the position information of the identification part of each of the target objects in each of the adjacent video frames in the target coordinate system.

8. The device for tracking the plurality of target objects in the motion state according to claim 6, further comprising:
a motion area determining unit configured to determine an actual motion area of each of the target objects in the video frames;
a filtering unit configured to take the actual motion area of each of the target objects in the video frames as a to-be-detected area, and filter out the feature detection areas outside the to-be-detected area to obtain the feature detection areas within the to-be-detected area.

9. An electronic device comprising:
a processor; and
a memory configured to store a program for a method for tracking a plurality of target objects in a motion state, wherein
after the electronic device is powered on and the processor runs the program for the method for tracking the plurality of target objects in the motion state, the electronic device performs following steps:
obtaining video frames comprised in video data captured by a video capture device;
sending the video frames to a preset feature recognition model; determining, for each of the video frames, feature detection areas corresponding to the target objects respectively; extracting, for each of the target objects, a color feature of each of the target objects from each of the feature detection areas corresponding to each of the target objects; and comparing the color feature of each of the target objects in each of adjacent video frames to obtain a first comparison result;
determining, for each of the adjacent video frames, position information of an identification part of each of the target objects in each of the adjacent video frames in a target coordinate system, and comparing the position information of the identification part in the target coordinate system for each of the adjacent video frames to obtain a second comparison result; and
determining whether the target objects in each of the adjacent video frames are the same target object based on the first comparison result and the second comparison result; regarding the target objects in each of the adjacent video frames as the same target object for tracking, in a case of determining that the target objects in each of the adjacent video frames are the same target object.

10. A storage device storing a program for a method for tracking a plurality of target objects in a motion state, wherein a processor runs the program to performs following steps:
obtaining video frames comprised in video data captured by a video capture device;
sending the video frames to a preset feature recognition model; determining, for each of the video frames, feature detection areas corresponding to the target objects respectively; extracting, for each of the target objects, a color feature of each of the target objects from each of the feature detection areas corresponding to each of the target objects; and comparing the color feature of each of the target objects in each of adjacent video frames to obtain a first comparison result;
determining, for each of the adjacent video frames, position information of an identification part of each of the target objects in each of the adjacent video frames in a target coordinate system, and comparing the position information of the identification part in the target coordinate system for each of the adjacent video frames to obtain a second comparison result; and
determining whether the target objects in each of the adjacent video frames are the same target object based on the first comparison result and the second comparison result; regarding the target objects in each of the adjacent video frames as the same target object for tracking, in a case of determining that the target objects in each of the adjacent video frames are the same target object.
